(19) United States
(12) Patent Application Publication
(10) Pub. No.: US 2010/0194070 A1
(43) Pub. Date: Aug. 5, 2010

(54) RUNNING BOARD SYSTEM FOR A VEHICLE

(75) Inventors: Louise E. Stauffer, Bloomfield Hills, MI (US); Andrew J. Hanzel, Washington, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/472,612

(22) Filed: May 27, 2009

Related U.S. Application Data
(60) Provisional application No. 61/150,141, filed on Feb. 5, 2009.

(51) Int. Cl. B60R 3/00

(52) U.S. Cl. 280/166; 280/163

(57) ABSTRACT

A vehicle includes a plurality of doors on one side of the vehicle, a running board system, an actuator, and a control module. The running board system is configured for enabling access to the vehicle and includes a first running board and a second running board. The first running board is configured for enabling access to the vehicle via a front door on the side of the vehicle and the second running board is configured for enabling access to the vehicle via a rear door on the side of the vehicle. Each of the first running board and the second running board is individually deployable upon opening of the front door or the rear door.

### CROSS-REFERENCE TO RELATED APPLICATIONS

This application claims the benefit of U.S. Provisional Application 61/150,141, filed on Feb. 5, 2009, which is hereby incorporated by reference in its entirety.

### TECHNICAL FIELD

The present invention generally relates to a running board system for a vehicle.

### BACKGROUND OF THE INVENTION

High ground clearance vehicles typically have a vehicle floor disposed at a high elevation. Certain types of high ground clearance vehicles, such as sport utility vehicles and pick-up trucks with an extended cab, often include both a front door and a rear door on one side of the vehicle, and are designed to carry multiple occupants. Because of the high elevation of the vehicle floor, ingress and egress of high ground clearance vehicles and/or access to a roof of the vehicle may be cumbersome for some occupants. To compensate for the high elevation, high ground clearance vehicles may include running boards to assist occupants during ingress and egress of the vehicle and/or to provide access to the roof of the vehicle.

Existing running boards typically extend longitudinally along a passenger side and/or a driver side of the vehicle and may be fixed or retractable. However, such existing running boards are not customizable according to individual occupant preferences at each vehicle door.

### SUMMARY OF THE INVENTION

A running board system configured for enabling access to a vehicle having a plurality of doors on one side of the vehicle includes a first running board and a second running board. The first running board is configured for enabling access to the vehicle via a front door on the side of the vehicle and the second running board is configured for enabling access to the vehicle via a rear door on the side of the vehicle. Each of the first running board and the second running board is individually deployable upon opening of the front door or the rear door.

A running board system configured for enabling access to a vehicle having a plurality of doors on each of two sides of the vehicle includes a first running board and a second running board. The first running board is configured for enabling access to the vehicle via a front door of a driver side of the vehicle, and the second running board is configured for enabling access to the vehicle via a rear door of the driver side of the vehicle. The running board system also includes a third running board and a fourth running board. The third running board is configured for enabling access to the vehicle via a front door of a passenger side of the vehicle, and the fourth running board is configured for enabling access to the vehicle via a rear door of the passenger side of the vehicle. Each of the first running board and the second running board is individually deployable upon opening of the front door of the driver side or the rear door of the driver side, and each of the first running board and the second running board is individually retractable upon closing of the front door of the driver side or the rear door of the driver side. Each of the third running board and the fourth running board is individually deployable upon opening of the front door of the passenger side or the rear door of the passenger side, and each of the third running board and the fourth running board is individually retractable upon closing of the front door of the passenger side or the rear door of the passenger side.

A vehicle includes a plurality of doors on one side of the vehicle and the running board system. The vehicle also includes an actuator configured for receiving a signal and individually deploying and individually retracting each of the first running board and the second running board. Additionally, the vehicle includes a control module configured for transmitting a signal to the actuator. Each of the first running board and the second running board is individually deployable upon opening of the front door or the rear door, and each of the first running board and the second running board is individually retractable upon closing of the front door or the rear door.

The running board system of the present invention assists occupants during ingress and egress of high ground clearance vehicles and/or provides access to a roof of the vehicle. Further, the vehicle and running board system are customizable according to individual occupant preferences during ingress and/or egress of the vehicle at each vehicle door. Since the running board system may include a seal and/or a deflector, the running board system also provides a clean stepping surface for occupants. Finally, as compared to existing running board systems, the running board system of the present invention may not add incremental weight to the vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a running board system disposed on a vehicle;

FIG. 2A is a schematic side view of a first running board of the running board system of FIG. 1 individually deployed upon opening of a front door of the vehicle, and a second running board of the running board system of FIG. 1 individually retracted upon closing of a rear door of the vehicle;

FIG. 2B is an enlarged schematic perspective view of a portion of the first running board of FIG. 2A;

FIG. 3A is a schematic side view of each of the first running board and the second running board of FIG. 2A individually retracted upon closing of the front door and the rear door of the vehicle;

FIG. 3B is an enlarged schematic perspective view of the first running board and a portion of the second running board of FIG. 3A disposed in a retracted position;

FIG. 4 is a schematic perspective view of the first running board of FIG. 2A individually retracted upon opening of the front door of the vehicle, and the second running board of FIG. 2A individually deployed upon opening of a rear door of the vehicle;

FIG. 5 is a schematic side view of the vehicle of FIG. 1 including a control module and an actuator;

FIG. 6 is a schematic perspective view of the actuator of FIG. 5 and a plurality of brackets configured for attaching the first running board of FIG. 2A to the vehicle;

FIG. 7 is a schematic cross-sectional view of the first running board along section line 7-7 of FIG. 2B configured for deflecting debris and disposed in the retracted position;

FIG. 8 is a schematic perspective view of the first running board of FIG. 2A deployed to a plurality of positions;

FIG. 9 is a schematic top view of another embodiment of the running board system including a third running board and a fourth running board, each configured for enabling access to a vehicle having a front door and a rear door of a passenger side of the vehicle; and

FIG. 10 is a schematic rear perspective view of the running board system of FIG. 9 wherein the third running board is individually deployed upon opening of the front door of the passenger side of the vehicle and the fourth running board is individually retracted upon opening of the rear door of the passenger side of the vehicle.

### DESCRIPTION OF THE PREFERRED EMBODIMENTS

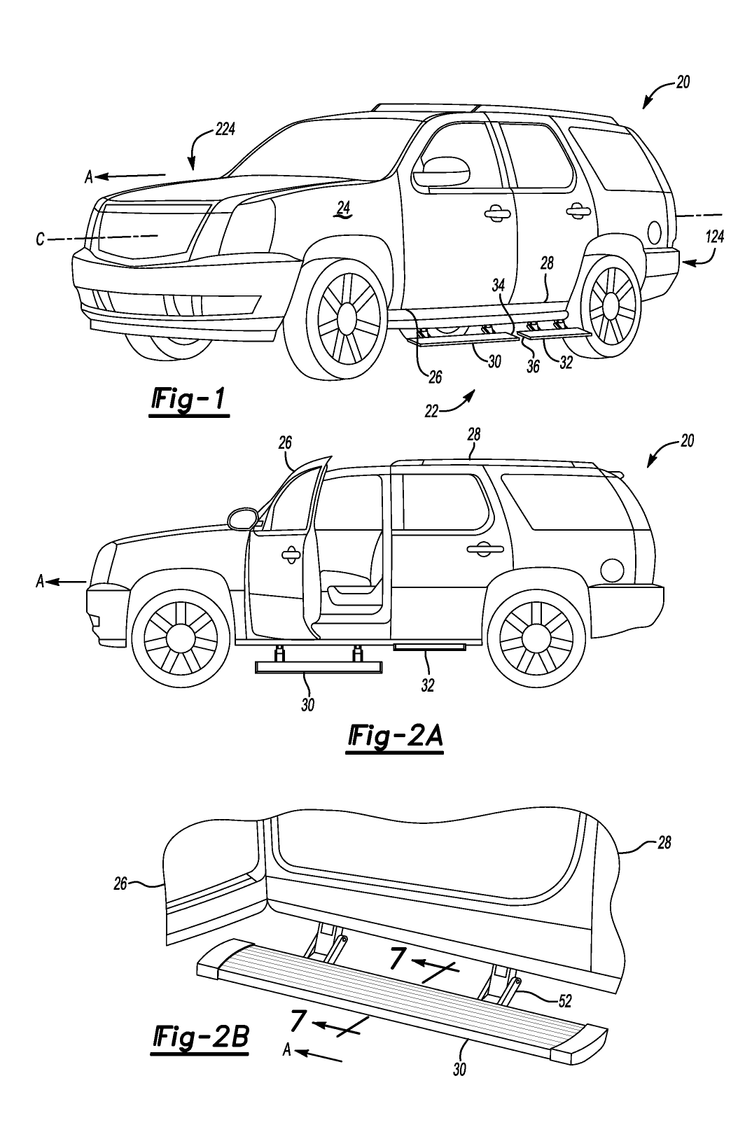

Referring to the drawings, wherein like reference numerals refer to like components, a vehicle is shown generally at 20 in FIG. 1. The vehicle 20 includes a running board system, shown generally at 22 and set forth in more detail below. The running board system 22 is generally useful for automotive applications, such as sport utility vehicles and pick-up trucks having an extended cab. However, it is to be appreciated that the running board system 22 may also be useful for non-automotive applications, such as, but not limited to, rail and recreational vehicle applications.

Referring to FIG. 1, in one embodiment, the vehicle 20 may be a high ground clearance vehicle, i.e., a vehicle having both a floor and roof disposed at a comparatively higher elevation than a passenger sedan. For example, the vehicle 20 may be a sport utility vehicle, a cross-over utility vehicle, an off-road vehicle, or a pick-up truck. The vehicle 20 includes a plurality of doors on one side 24 of the vehicle 20. The plurality of doors may include a front door 26 and a rear door 28. As used herein, directional terminology such as front, rear, and back retain conventional meaning. That is, the terminology “front” refers to elements associated with a portion of the vehicle 20 which reaches a destination first during travel in the direction of arrow A. That is, front elements are often disposed close to the headlights of the vehicle 20. In contrast, elements described as “rear” or “back” are often disposed toward the taillights of the vehicle 20.

The side 24 of the vehicle 20 may be a driver side 124 or a passenger side 224. In another embodiment, the one side 24 may be a rear side of the vehicle 20. As used herein, the terminology driver and passenger retain conventional meaning as used in the vehicle art. That is, the terminology “driver” refers to elements of the vehicle 20 which are disposed on a side 24 of the vehicle 20 having a steering column (not shown). In contrast, the terminology “passenger” refers to elements of the vehicle 20 which are disposed on a side 24 opposite the driver side 124. Therefore, in one embodiment, the vehicle 20 is a high ground clearance vehicle having the front door 26 and the rear door 28 on the driver side 124 of the vehicle 20.

As set forth above, the vehicle 20 includes the running board system 22. The running board system 22 is configured for enabling access to the vehicle 20. That is, the running board system 22 may assist an occupant, such as a driver, a passenger, or an animal, during ingress and/or egress of the vehicle 20 and/or may provide access to the roof of the vehicle 20.

Referring to FIG. 1, the running board system 22 includes a first running board 30 and a second running board 32. The first running board 30 is configured for enabling access to the vehicle 20 via the front door 26 on the side 24 of the vehicle 20. That is, the first running board 30 may be disposed beneath the front door 26 of the vehicle 20. For example, the first running board 30 may be attached to a portion of an underside of the vehicle 20 disposed adjacent the front door 26 on the side 24 of the vehicle 20.

The second running board 32 is configured for enabling access to the vehicle 20 via the rear door 28 on the side 24 of the vehicle 20. That is, the second running board 32 may be disposed beneath the rear door 28 of the vehicle 20. For example, the second running board 32 may be attached to a portion of the underside of the vehicle 20 disposed adjacent the rear door 28 on the side 24 of the vehicle 20.

Referring to FIGS. 2A and 2B, each of the first running board 30 and the second running board 32 may be longitudinally-elongated. That is, a length of each of the first running board 30 and the second running board 32 may be longer than a width of the each of the first running board 30 and the second running board 32, respectively, so that each of the first running board 30 and the second running board 32 extends longitudinally along the side 24 of the vehicle 20 during vehicle travel in the direction of arrow A. For example, the length of each of the first running board 30 and the second running board 32 may be longer than twice the width of each of the first running board 30 and the second running board 32, respectively. Stated differently, referring to FIG. 1, a rear end 34 of the first running board 30 may be adjacent a front end 36 of the second running board 32.

Referring to FIG. 7, each of the first running board 30 and the second running board 32 (not shown) may have a non-circular cross-sectional shape. As used herein, the terminology non-circular does not preclude arcuate portions of the cross-sectional shape. However, the terminology non-circular does preclude a wholly-circular cross-sectional shape. For example, referring to FIGS. 1 and 7, each of the first running board 30 and the second running board 32 may have a wing-shaped cross-sectional shape wherein a thicker portion of the first running board 30 or second running board 32 is disposed closer to a central longitudinal axis C of the vehicle 20. Similarly, in this embodiment, a thinner portion of the first running board 30 or the second running board 32 may be disposed farther from the central longitudinal axis C of the vehicle 20. In another embodiment, each of the first running board 30 and the second running board 32 may have, for example, a box-shaped, generally cylindrical, or hexagonal cross-section. That is, any non-circular cross-sectional shape is suitable for purposes of the present invention, since each of the first running board 30 and the second running board 32 may be useful as an assist step for ingress and/or egress of the vehicle 20 and/or for providing access to the roof of the vehicle 20. It is to be appreciated that the first running board 30 may have a similar or different shape than the second running board 32.

Each of the first running board 30 and the second running board 32 may have a cross-sectional thickness, t, of from 0.25 to 3, more preferably 0.5 to 2 inches. More specifically, in the embodiment having the thicker portion and the thinner portion as set forth above, the thicker portion may have a cross-sectional thickness, t, of from 1 to 2 inches, and the thinner portion may have a cross-sectional thickness, t, of from 0.5 to 0.75 inches.

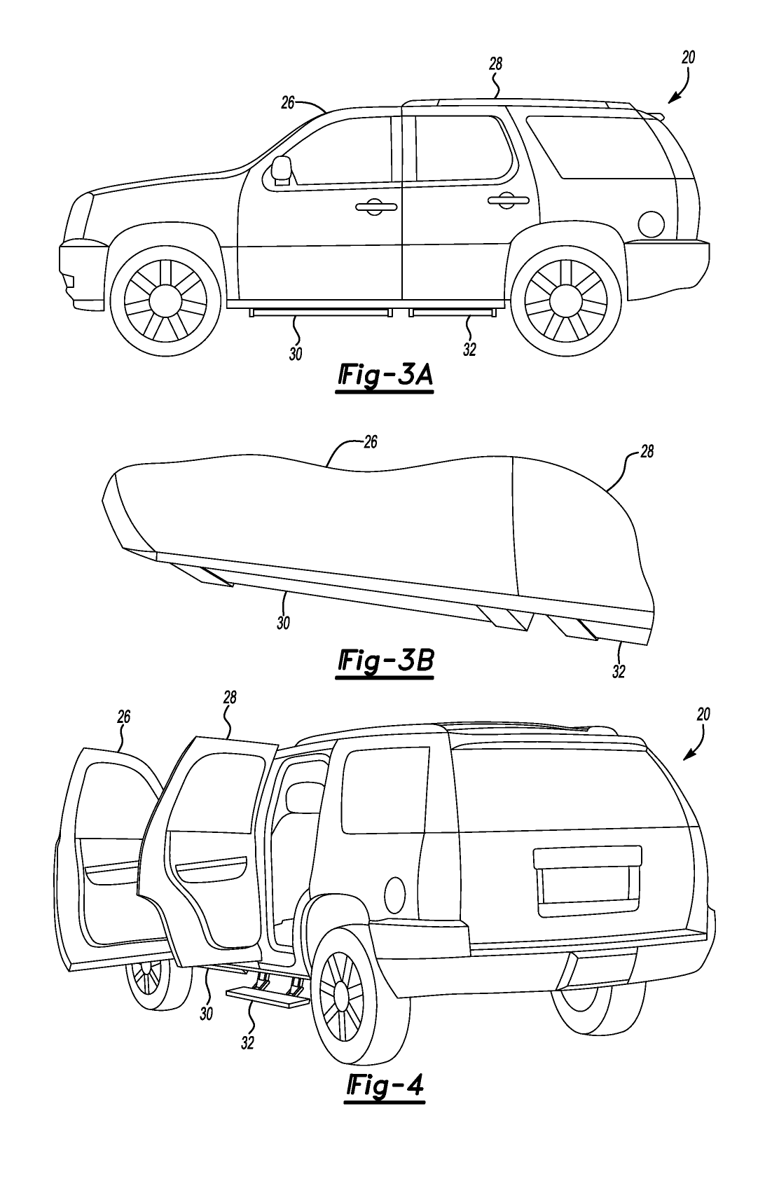

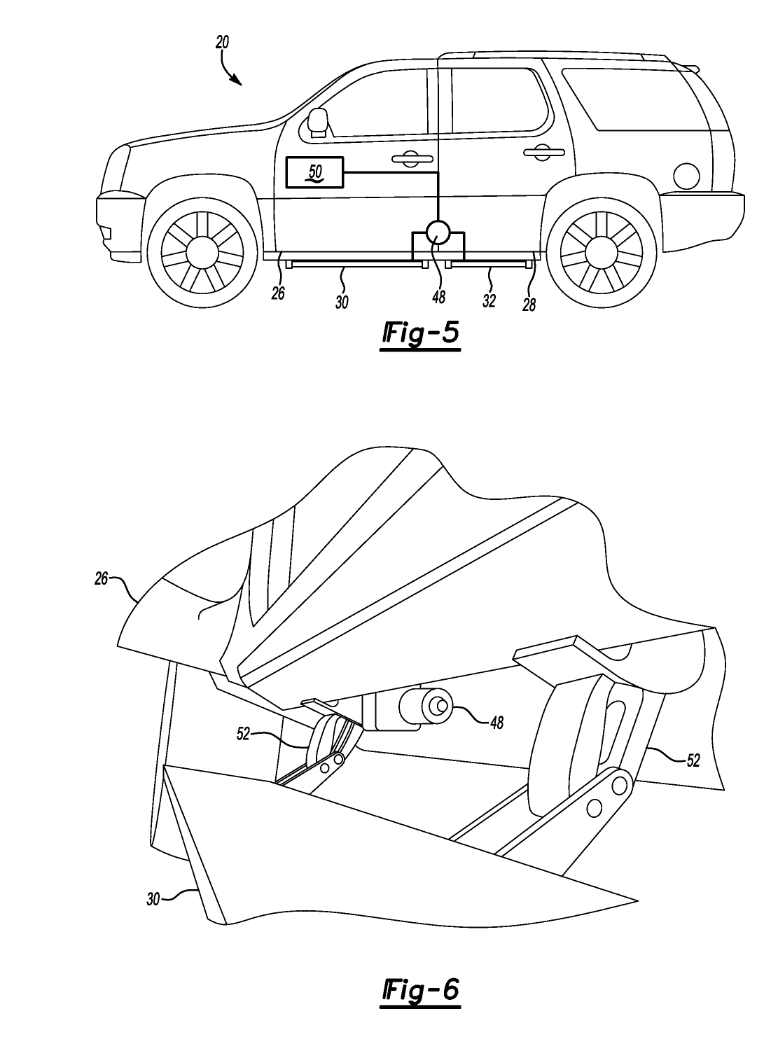

Referring to FIGS. 2A and 4, each of the first running board 30 and the second running board 32 is individually deployable upon opening of the front door 26 or the rear door 28. In particular, the terminology individually deployable denotes that the first running board 30 and the second running board 32 may be selectively actuated, e.g., deployed, independently from one another. Generally, each of the first running board 30 and the second running board 32 may be deployed to assist the occupant during ingress and/or egress of the vehicle 20 and/or to provide access to the roof of the vehicle 20. For example, the first running board 30 may be deployed upon opening of the front door 26 to assist the occupant with ascent into the vehicle 20. Or, the first running board 30 may be deployed upon opening of the front door 26 to assist the occupant with descent from the vehicle 20. Additionally, the first running board 30 may be deployed upon opening of the front door 26 to provide access to a front of the roof of the vehicle 20.

More specifically, referring to FIG. 2A, upon opening of the front door 26, only the first running board 30 may be deployed. Such an embodiment may be useful, for example, for a relatively shorter occupant or for an occupant requiring assistance due to infirmity, disability, and/or restrictive clothing, or based upon occupant preference. Alternatively, upon opening of the front door 26, neither the first running board 30 nor the second running board 32 may be deployed. Such an embodiment may be useful, for example, for a relatively taller occupant. Similarly, referring to FIG. 4, upon opening of the front door 26, only the second running board 32 may be deployed. Such an embodiment may be useful, for example, for an occupant reaching for an object at a rear of the roof of the vehicle 20 or for an occupant requiring a momentary support for packages. Finally, upon opening of the front door 26, both the first running board 30 and the second running board 32 may be deployed. Such an embodiment may be useful, for example, for an occupant loading objects along an entire length of the roof of the vehicle 20.

Likewise, referring to FIG. 4, upon opening of the rear door 28, only the second running board 32 may be deployed. Such an embodiment may be useful, for example, for a relatively shorter occupant or for an occupant requiring assistance due to infirmity, disability, and/or restrictive clothing, or based upon occupant preference. Alternatively, upon opening of the rear door 28, neither the first running board 30 nor the second running board 32 may be deployed. Such an embodiment may be useful, for example, for a relatively taller occupant. Similarly, upon opening of the rear door 28, only the first running board 30 may be deployed. Such an embodiment may be useful, for example, for an occupant reaching for an object at the front of the roof of the vehicle 20 or for an occupant requiring a momentary support for packages. Finally, upon opening of the rear door 28, both the first running board 30 and the second running board 32 may be deployed. Such an embodiment may be useful, for example, for an occupant loading objects along an entire length of the roof of the vehicle 20.

Referring also to FIGS. 1 and 3A, each of the first running board 30 and the second running board 32 is individually retractable upon closing of the front door 26 or the rear door 28. In particular, the terminology individually retractable denotes that the first running board 30 and the second running board 32 may be selectively actuated, e.g., retracted, independently from one another. Generally, each of the first running board 30 and the second running board 32 may also be retracted to assist the occupant during ingress and/or egress of the vehicle 20 and/or to provide access to the roof of the vehicle 20. For example, the first running board 30 may be retracted upon closing of the front door 26 after assisting the occupant with ascending into the vehicle 20. Or, the first running board 30 may be retracted upon closing of the front door 26 after assisting the occupant with descending from the vehicle 20. Additionally, the first running board 30 may be retracted upon closing of the front door 26 for an occupant not requiring access to the roof of the vehicle 20.

More specifically, upon closing of the front door 26, only the first running board 30 may be retracted. Such an embodiment may be useful, for example, for an occupant who specifies that only the first running board 30 be deployed upon opening of the front door 26. Alternatively, referring to FIG. 1, upon closing of the front door 26, neither the first running board 30 nor the second running board 32 may be retracted. Such an embodiment may be useful, for example, for an occupant who prefers the first running board 30 and the second running board 32 to customarily remain deployed based on aesthetics or utility, such as roof accessibility. Similarly, upon closing of the front door 26, only the second running board 32 may be retracted. Such an embodiment may be useful for an occupant who prefers deployment of the second running board 32 upon opening of the front door 26. Finally, referring to FIG. 3A, upon closing of the front door 26, both the first running board 30 and the second running board 32 may be retracted. Such an embodiment may be useful, for example, for an occupant who prefers deployment of the first running board 30 and the second running board 32 upon opening of the front door 26.

Likewise, referring to FIG. 2A, upon closing of the rear door 28, only the second running board 32 may be retracted. Again, such an embodiment may be useful, for example, for an occupant who prefers deployment of the second running board 32 upon opening of the rear door 28. Alternatively, referring to FIG. 1, upon closing of the rear door 28, neither the first running board 30 nor the second running board 32 may be retracted. Such an embodiment may be useful, for example, for an occupant who prefers the first running board 30 and the second running board 32 to customarily remain deployed based on aesthetics or utility, such as roof accessibility. Similarly, upon closing of the rear door 28, only the first running board 30 may be retracted. Such an embodiment may be useful, for example, for an occupant who prefers deployment of the first running board 30 upon opening of the rear door 28. Finally, referring to FIG. 3A, upon closing of the rear door 28, both the first running board 30 and the second running board 32 may be retracted. Such an embodiment may be useful, for example, for an occupant who prefers deployment of the first running board 30 and the second running board 32 upon opening of the rear door 28.

It is to be appreciated that while the vehicle 20 is in motion, each of the first running board 30 and the second running board 32 may be retracted to minimize degradation of fuel economy and maximize cleanliness of each of the first running board 30 and the second running board 32. It is also to be appreciated that while the vehicle 20 is in motion, individual deployment and/or retraction of each of the first running board 30 and the second running board 32 preferably may not be initiated. That is, while the vehicle 20 is in motion, the occupant preferably may not individually deploy each of the first running board 30 and/or the second running board 32. Similarly, while the vehicle 20 is in motion, the occupant preferably may not individually retract each of the first running board 30 and/or the second running board 32.

In one embodiment, each of the first running board 30 and the second running board 32 is individually deployable upon opening of the front door 26 or the rear door 28, respectively. That is, the first running board 30 may be deployable upon opening of the front door 26 and the second running board 32 may be deployable upon opening of the rear door 28.

In another embodiment, each of the first running board 30 and the second running board 32 is individually retractable upon closing of the front door 26 or the rear door 28, respectively. That is, the first running board 30 may be retractable upon closing of the front door 26 and the second running board 32 may be retractable upon closing of the rear door 28.

Each of the first running board 30 and the second running board 32 may be powered. That is, each of the first running board 30 and the second running board 32 may be automatically deployable. Similarly, each of the first running board 30 and the second running board 32 may be automatically retractable. That is, each of the first running board 30 and the second running board 32 may not require manual deployment or retraction by the occupant. The first running board 30 and the second running board 32 may be, for example, electrically powered via an on-board power source, such as a vehicle battery (not shown).

Further, individual deployment and/or individual retraction of each of the first running board 30 and the second running board 32 may be programmable according to occupant preferences. In one example, individual deployment and/or individual retraction may be actuated in conjunction with a controller (not shown) and/or on-board vehicle sensors (not shown), e.g. optical or weight sensors that determine whether a vehicle seat is occupied and/or sensors located in a door jamb of the vehicle 20 that determine whether one of the front door 26 and the rear door 28 of the vehicle is in an open position. Additionally, individual deployment and/or individual retraction of each of the first running board 30 and the second running board 32 may actuate other vehicle components, such as, but not limited to, audible tones, lighting, and/or a step (not shown) disposed underneath a back of the vehicle 20 and configured for deployment and retraction.

Additionally, individual deployment and/or individual retraction of each of the first running board 30 and the second running board 32 may be controlled via one or more override switches (not shown). Thus, an occupant may override previously-set occupant preferences or presently-non-desired deployment and/or retraction, via the one or more override switches so as to individually deploy and/or individually retract each of the first running board 30 and/or the second running board 32. Such functionality may be useful, for example, when one occupant desires to override occupant preferences previously set by another occupant. Such functionality may also be useful, for example, when the occupant wishes to individually deploy each of the first running board 30 and/or the second running board 32 upon closing of the front door 26 and/or the rear door 28 during a vehicle wash or when the vehicle 20 is parked.

Referring to FIG. 8, each of the first running board 30 and the second running board 32 (not shown) may be individually deployable to a plurality of positions. That is, referring additionally to FIG. 3B, each of the first running board 30 and the second running board 32 may be individually deployable from a retracted position 37 underneath the vehicle 20 to the plurality of positions. For example, each of the first running board 30 and the second running board 32 may be deployable to a first position 38, a second position 40, and a third position 42, corresponding to increasing elevations and/or desired accessibility to the roof of the vehicle 20. Similarly, each of the first running board 30 and the second running board 32 may be individually retractable to the plurality of positions. For example, the first running board 30 may be individually deployable and individually retractable between the first position 38 and the second position 40 without first retracting to the retracted position 37 underneath the vehicle 20. Deployment of the first running board 30 and/or the second running board 32 to the first position 38 may be useful for an occupant requiring minimal distance between the first running board 30 and/or the second running board 32 and the ground, whereas deployment to the third position 42 may be useful for an occupant requiring minimal distance between the first running board 30 and/or the second running board 32 and a seat (not shown) of the vehicle 20. Additionally, individual deployment and/or individual retraction of the first running board 30 and/or the second running board 32 to the plurality of positions may be programmable according to occupant preferences. That is, each of the first running board 30 and the second running board 32 may accommodate varying occupant size, ability, and/or agility.

In another example, each of the first running board 30 and the second running board 32 may deploy horizontally farther from the vehicle 20. That is, the first running board 30 and/or the second running board 32 may deploy to one or more selectable distances away from the central longitudinal axis C (FIG. 1) of the vehicle 20. For example, each of the first running board 30 and the second running board 32 may deploy a relatively short distance from the vehicle 20 for an occupant requiring comparatively less leverage during ingress and/or egress of the vehicle 20. Likewise, each of the first running board 30 and the second running board 32 may deploy a relatively larger distance from the vehicle 20 for an occupant requiring comparatively more leverage during ingress and/or egress of the vehicle 20. Further, each of the first running board 30 and the second running board 32 may be laterally extendable so as to provide a wider or narrower step for an occupant.

Referring to FIG. 3B, each of the first running board 30 and the second running board 32 may be configured for deflecting debris when disposed in the retracted position 37. Since the running board system 22 is generally useful for automotive applications, the running board system 22 may be exposed to debris such as dirt, snow, rain, and/or road components during use. In one embodiment, each of the first running board 30 and the second running board 32 may engage a seal, shown generally at 43 in FIG. 7 for the first running board 30. For example, the seal 43 may be disposed underneath the vehicle 20 along an underside edge configured for abutting the first running board 30 and/or the second running board 32. Alternatively, the seal 43 may be disposed on one or more edges of an uppermost surface, i.e., a stepping surface, of each of the first running board 30 and the second running board 32. The seal 43 may surround a periphery, or a portion of the periphery, of the uppermost surface of each of the first running board 30 and the second running board 32. As each of the first running board 30 and the second running board 32 is individually retracted to the retracted position 37 underneath the vehicle 20, each of the first running board 30 and/or the second running board 32 may engage the seal 43, e.g. compress the seal 43, and deflect debris from each of the first running board 30 and the second running board 32. The seal 43 may be formed from any suitable sealing material known in the art. For example, the seal 43 may be rubber.

Alternatively or additionally, in another embodiment, each of the first running board 30 and the second running board 32 may include a deflector. The deflector may be, for example, a shield or plate that is configured to protect each of the first running board 30 and the second running board 32 from debris, particularly debris emanating from a rotating tire of the vehicle 20 or from other nearby vehicles. The deflector may be disposed at the front of each of the first running board 30 and the second running board 32 and may be positioned to deflect debris away from each of the first running board 30 and the second running board 32. That is, the deflector may augment the seal 43 and further minimizes debris exposure via any gaps in the seal 43 of each of the first running board 30 and the second running board 32.

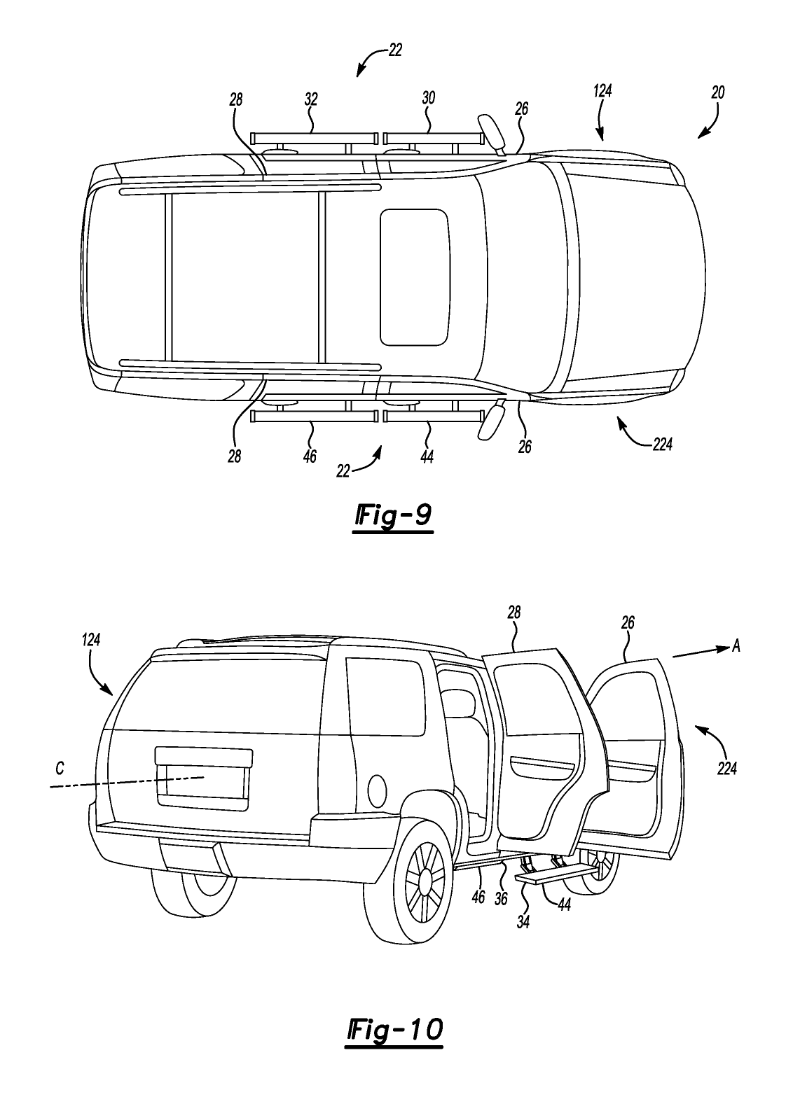

Referring to FIG. 9, in another embodiment, the running board system 22 includes the first running board 30 configured for enabling access to the vehicle 20 via the front door 26 of the driver side 124 of the vehicle 20, and the second running board 32 configured for enabling access to the vehicle 20 via the rear door 28 of the driver side 124 of the vehicle 20. In this embodiment, the running board system 22 also includes a third running board 44 and a fourth running board 46. The third running board 44 is configured for enabling access to the vehicle 20 via the front door 26 of the passenger side 224 of the vehicle 20, and the fourth running board 46 is configured for enabling access to the vehicle 20 via the rear door 28 of the passenger side 224 of the vehicle 20. That is, the running board system 22 including the third running board 44 and the fourth running board 46 may assist an occupant during ingress and/or egress of the vehicle 20 and/or may provide access to the roof of the vehicle 20 from either the driver side 124 or the passenger side 224 of the vehicle 20.

The third running board 44 may be disposed beneath the front door 26 of the passenger side 224 of the vehicle 20. For example, the third running board 44 may be attached to a portion of the underside of the vehicle 20 disposed adjacent the front door 26 of the passenger side 224 of the vehicle 20. Similarly, the fourth running board 46 may be disposed beneath the rear door 28 of the passenger side 224 of the vehicle 20. For example, the fourth running board 46 may be attached to a portion of the underside of the vehicle 20 disposed adjacent the rear door 28 on the passenger side 224 of the vehicle 20.

Referring to FIG. 10, each of the third running board 44 and the fourth running board 46 may be longitudinally-elongated. That is, a length of each of the third running board 44 and the fourth running board 46 may be longer than a width of the each of the third running board 44 and the fourth running board 46, respectively, so that each of the third running board 44 and the fourth running board 46 extends longitudinally along the side 24 of the vehicle 20 during vehicle travel in the direction of arrow A. For example, the length of each of the third running board 44 and the fourth running board 46 may be longer than twice the width of each of the third running board 44 and the fourth running board 46, respectively. Stated differently, referring to FIG. 10, a rear end 34 of the third running board 44 may be adjacent a front end 36 of the fourth running board 46.

Further, each of the third running board 44 and the fourth running board 46 may have a non-circular cross-sectional shape. For example, each of the third running board 44 and the fourth running board 46 may have a wing-shaped cross-sectional shape wherein a thicker portion of the third running board 44 or fourth running board 46 is disposed closer to the central longitudinal axis C of the vehicle 20. Similarly, in this embodiment, a thinner portion of the third running board 44 or the fourth running board 46 may be disposed farther from the central longitudinal axis C of the vehicle 20. In another embodiment, each of the third running board 44 and the fourth running board 46 may have, for example, a box-shaped, generally cylindrical, or hexagonal cross-section. That is, any non-circular cross-sectional shape is suitable for purposes of the present invention, since each of the third running board 44 and the fourth running board 46 is generally useful as an assist step for ingress and/or egress of the vehicle 20 and/or for providing access to the roof of the vehicle 20. It is to be appreciated that the third running board 44 may have a similar or different shape than the fourth running board 46. Also, any one of the first running board 30, the second running board 32, the third running board 44, and the fourth running board 46 may be similarly or differently shaped than any other running board.

Each of the third running board 44 and the fourth running board 46 may have a cross-sectional thickness, t, of from 0.25 to 3, more preferably 0.5 to 2 inches. More specifically, in the embodiment having the thicker portion and the thinner portion as set forth above, the thicker portion may have a cross-sectional thickness, t, of from 1 to 2 inches, and the thinner portion may have a cross-sectional thickness, t, of from 0.5 to 0.75 inches.

Referring to FIGS. 9 and 10, in this embodiment, each of the first running board 30 and the second running board 32 is individually deployable upon opening of the front door 26 of the driver side 124 or the rear door 28 of the driver side 124. Similarly, each of the first running board 30 and the second running board 32 is individually retractable upon closing of the front door 26 of the driver side 124 or the rear door 28 of the driver side 124. Further, each of the third running board 44 and the fourth running board 46 is individually deployable upon opening of the front door 26 of the passenger side 224 or the rear door 28 of the passenger side 224.

Again, as used herein, the terminology individually deployable denotes that the third running board 44 and the fourth running board 46 may be selectively actuated, e.g., deployed, independently from one another. Generally, each of the third running board 44 and the fourth running board 46 may be deployed to assist the occupant during ingress and/or egress of the vehicle 20 and/or to provide access to the roof of the vehicle 20. For example, the third running board 44 may be deployed upon opening of the front door 26 of the passenger side 224 of the vehicle 20 to assist the occupant with ascent into the vehicle 20. Or, the third running board 44 may be deployed upon opening of the front door 26 of the passenger side 224 to assist the occupant with descent from the vehicle 20. Additionally, the third running board 44 may be deployed to provide access to the roof of the vehicle 20.

More specifically, referring to FIG. 10, upon opening of the front door 26 of the passenger side 224, only the third running board 44 may be deployed. Alternatively, upon opening of the front door 26 of the passenger side 224, neither the third running board 44 nor the fourth running board 46 may be deployed. Similarly, upon opening of the front door 26 of the passenger side 224, only the fourth running board 46 may be deployed. Finally, upon opening of the front door 26 of the passenger side 224, both the third running board 44 and the fourth running board 46 may be deployed.

Likewise, upon opening of the rear door 28 of the passenger side 224, only the fourth running board 46 may be deployed. Alternatively, upon opening of the rear door 28 of the passenger side 224, neither the third running board 44 nor the fourth running board 46 may be deployed. Similarly, upon opening of the rear door 28 of the passenger side 224, only the third running board 44 may be deployed. Finally, upon opening of the rear door 28 of the passenger side 224, both the third running board 44 and the fourth running board 46 may be deployed.

Similarly, each of the third running board 44 and the fourth running board 46 is individually deployable upon closing of the front door 26 of the passenger side 224 or the rear door 28 of the passenger side 224. Again, as used herein, the terminology individually retractable denotes that the third running board 44 and the fourth running board 46 may be selectively actuated, e.g., retracted, independently from one another. Generally, each of the third running board 44 and the fourth running board 46 may also be retracted to assist the occupant during ingress and/or egress of the vehicle 20. For example, the third running board 44 may be retracted upon closing of the front door 26 of the passenger side 224 of the vehicle 20 after assisting the occupant with ascending into the vehicle 20. Or, the third running board 44 may be retracted upon closing of the front door 26 of the passenger side 224 after assisting the occupant with descending from the vehicle 20. Additionally, the third running board 44 may be retracted for an occupant not requiring access to the roof of the vehicle 20.

More specifically, upon closing of the front door 26 of the passenger side 224, only the third running board 44 may be retracted. Alternatively, upon closing of the front door 26 of the passenger side 224, neither the third running board 44 nor the fourth running board 46 may be retracted. Similarly, upon closing of the front door 26 of the passenger side 224, only the fourth running board 46 may be retracted. Finally, upon closing of the front door 26 of the passenger side 224, both the third running board 44 and the fourth running board 46 may be retracted.

Likewise, upon closing of the rear door 28 of the passenger side 224, only the fourth running board 46 may be retracted. Alternatively, upon closing of the rear door 28 of the passenger side 224, neither the third running board 44 nor the fourth running board 46 may be retracted. Similarly, referring to FIG. 10, upon closing of the rear door 28 of the passenger side 224, only the third running board 44 may be retracted. Finally, upon closing of the rear door 28 of the passenger side 224, both the third running board 44 and the fourth running board 46 may be retracted.

It is to be appreciated that while the vehicle 20 is in motion, each of the third running board 44 and the fourth running board 46 is preferably retracted to minimize degradation of fuel economy and maximize cleanliness of each of the third running board 44 and the fourth running board 46. It is also to be appreciated that while the vehicle 20 is in motion, individual deployment and/or retraction of each of the third running board 44 and the fourth running board 46 preferably may not be initiated. That is, while the vehicle 20 is in motion, the occupant preferably may not individually deploy each of the third running board 44 and/or the fourth running board 46. Similarly, while the vehicle 20 is in motion, the occupant preferably may not individually retract each of the third running board 44 and/or the fourth running board 46.

In this embodiment, each of the first running board 30 and the second running board 32 is individually deployable upon opening of the front door 26 of the driver side 124 or the rear door 28 of the driver side 124, respectively, and each of the first running board 30 and the second running board 32 is individually retractable upon closing of the front door 26 of the driver side 124 or the rear door 28 of the driver side 124, respectively. That is, the first running board 30 may be deployable upon opening of the front door 26 of the driver side 124 and the second running board 32 may be deployable upon opening of the rear door 28 of the driver side 124. Further, the first running board 30 may be retractable upon closing of the front door 26 of the driver side 124 and the second running board 32 may be retractable upon closing of the rear door 28 of the driver side 124.

Moreover, in this embodiment, each of the third running board 44 and the fourth running board 46 is individually deployable upon opening of the front door 26 of the passenger side 224 or the rear door 28 of the passenger side 224, respectively, and each of the third running board 44 and the fourth running board 46 is individually retractable upon closing of the front door 26 of the passenger side 224 or the rear door 28 of the passenger side 224, respectively. That is, the third running board 44 may be deployable upon opening of the front door 26 of the passenger side 224 and the fourth running board 46 may be deployable upon opening of the rear door 28 of the passenger side 224. Further, the third running board 44 may be retractable upon closing of the front door 26 of the passenger side 224 and the fourth running board 46 may be retractable upon closing of the rear door 28 of the passenger side 224.

Each of the third running board 44 and the fourth running board 46 may be powered. That is, each of the third running board 44 and the fourth running board 46 may be automatically deployable. Similarly, each of the third running board 44 and the fourth running board 46 may be automatically retractable. That is, each of the third running board 44 and the fourth running board 46 may not require manual deployment or retraction by the occupant. The third running board 44 and the fourth running board 46 may be, for example, electrically powered via an on-board power source, such as a vehicle battery (not shown).

Further, individual deployment and/or individual retraction of each of the third running board 44 and the fourth running board 46 may be programmable according to occupant preferences. In one example, individual deployment and/or individual retraction may be actuated in conjunction with on-board vehicle sensors, e.g. optical or weight sensors that determine whether a vehicle seat is occupied and/or sensors located in the door jamb of the vehicle 20 that determine whether one of the front door 26 and the rear door 28 of the vehicle is in an open position. Additionally, individual deployment and/or individual retraction of each of the third running board 44 and the fourth running board 46 may actuate other vehicle components, such as, but not limited to, audible tones, lighting, and/or a step (not shown) disposed underneath a back of the vehicle 20 and configured for deployment and retraction.

Additionally, individual deployment and/or individual retraction of each of the third running board 44 and the fourth running board 46 may be controlled via one or more override switches (not shown). Thus, an occupant may override previously-set occupant preferences or presently-non-desired deployment and/or retraction, via the one or more override switches so as to individually deploy and/or individually retract each of the third running board 44 and/or the fourth running board 46. Such functionality may be useful, for example, when one occupant desires to override occupant preferences previously set by another occupant. Such functionality may also be useful, for example, when the occupant wishes to individually deploy each of the third running board 44 and/or the fourth running board 46 upon closing of the front door 26 of the passenger side 224 and/or the rear door 28 of the passenger side 224 during a vehicle wash or when the vehicle 20 is parked.

Additionally, each of the third running board 44 and the fourth running board 46 may be individually deployable to a plurality of positions. That is, each of the third running board 44 and the fourth running board 46 may be individually deployable from the retracted position 37 underneath the vehicle 20 to the plurality of positions. For example, each of the third running board 44 and the fourth running board 46 may be deployable to the first position 38, the second position 40, and the third position 42. Similarly, each of the third running board 44 and the fourth running board 46 may be individually retractable to the plurality of positions. For example, the third running board 44 may be individually deployable and individually retractable between the first position 38 and the second position 40 without first retracting to the retracted position 37 underneath the vehicle 20. Deployment of the third running board 44 and/or the fourth running board 46 to the first position 38 may be useful for an occupant requiring minimal distance between the third running board 44 and/or the fourth running board 46 and the ground, whereas deployment to the third position 42 may be useful for an occupant requiring minimal distance between the third running board 44 and/or the fourth running board 46 and a seat (not shown) of the vehicle 20. Additionally, individual deployment and/or individual retraction of the third running board 44 and/or the fourth running board 46 to the plurality of positions may be programmable according to occupant preferences. That is, each of the third running board 44 and the fourth running board 46 may accommodate varying occupant size, ability, and/or agility.

In another example, each of the third running board 44 and the fourth running board 46 may deploy horizontally farther from the vehicle 20. That is, the third running board 44 and/or the fourth running board 46 may deploy to one or more selectable distances away from the central longitudinal axis C of the vehicle 20. For example, each of the third running board 44 and the fourth running board 46 may deploy a relatively short distance from the vehicle 20 for an occupant requiring comparatively less leverage during ingress and/or egress of the vehicle 20. Likewise, each of the third running board 44 and the fourth running board 46 may deploy a relatively larger distance from the vehicle 20 for an occupant requiring comparatively more leverage during ingress and/or egress of the vehicle 20. Further, each of the third running board 44 and the fourth running board 46 may be laterally extendable so as to provide a wider or narrower step for an occupant.

Further, each of the first running board 30, the second running board 32, the third running board 44, and the fourth running board 46 may be configured for deflecting debris when disposed in the retracted position 37. For example, the seal 43 may be disposed underneath the vehicle 20 along an underside edge configured for abutting the third running board 44 and/or the fourth running board 46. Alternatively, the seal 43 may be disposed on one or more edges of an uppermost surface, i.e., a stepping surface, of each of the third running board 44 and the fourth running board 46. The seal 43 may surround a periphery, or a portion of the periphery, of the uppermost surface of each of the third running board 44 and the fourth running board 46. As each of the third running board 44 and the fourth running board 46 is individually retracted to the retracted position 37 underneath the vehicle 20, each of the third running board 44 and/or the fourth running board 46 may engage the seal 43, e.g. compress the seal 43, and deflect debris from each of the third running board 44 and the fourth running board 46.

Alternatively or additionally, in another embodiment, each of the third running board 44 and the fourth running board 46 may include the deflector. The deflector may be, for example, a shield or plate that is configured to protect each of the third running board 44 and the fourth running board 46 from debris, particularly debris emanating from a rotating tire of the vehicle 20 or from other nearby vehicles. The deflector may be disposed at the front of each of the third running board 44 and/or the fourth running board 46 and may be positioned to deflect debris away from each of the third running board 44 and the fourth running board 46. That is, the deflector may augment the seal 43 and further minimizes debris exposure via any gaps in the seal 43 of each of the third running board 44 and the fourth running board 46. Therefore, upon deployment after the vehicle 20 has been exposed to debris, the stepping surface of each of the first running board 30, the second running board 32, the third running board 44, and the fourth running board 46 may be substantially free from debris. That is, the seal 43 and/or deflector of the running board system 22 may contribute to a clean stepping surface for occupants after the vehicle 20 has been exposed to debris.

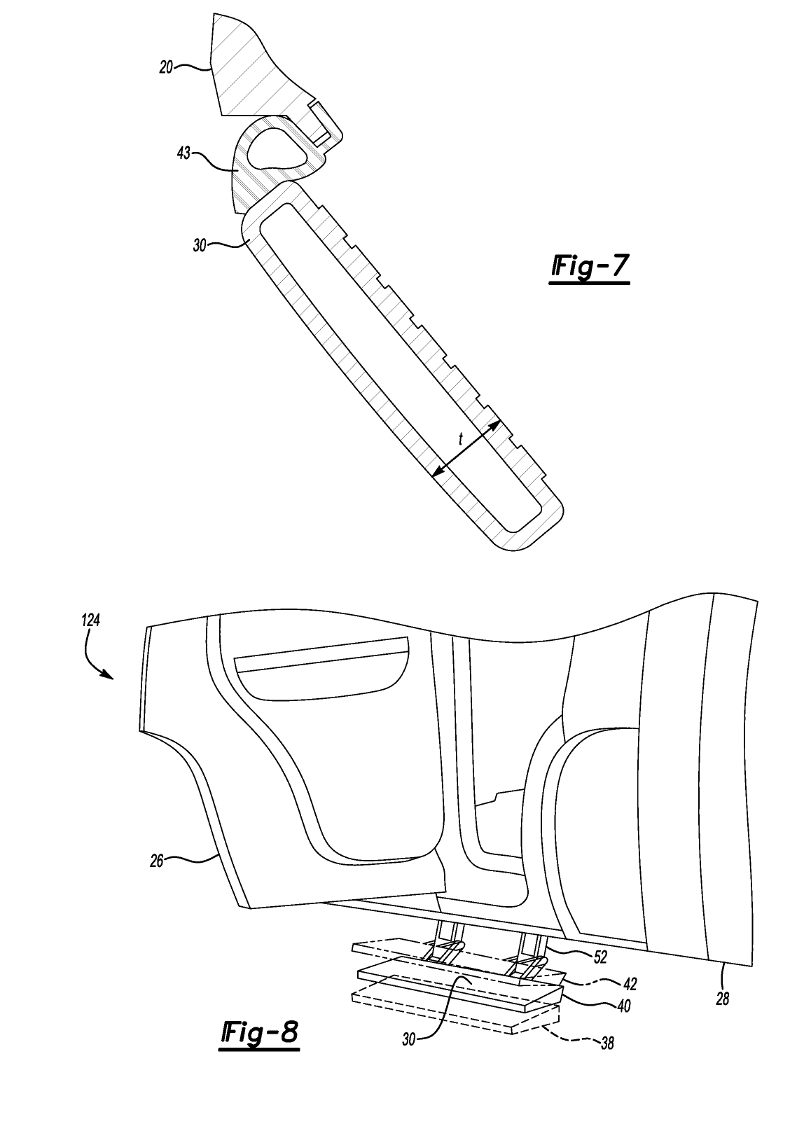

Referring to FIGS. 5 and 6, the vehicle 20 also includes an actuator 48 configured for receiving a signal and individually deploying and individually retracting each of the first running board 30 and the second running board 32. For example, the actuator 48 may be a drive motor that moves, e.g., deploys and/or retracts, each of the first running board 30 and the second running board 32 in response to the signal. In one embodiment, the signal is an electrical signal. In another embodiment, the signal is a pneumatic or a mechanical signal.

The vehicle 20 may include a plurality of actuators 48. That is, the vehicle 20 may include one or more actuators 48 per running board. For example, in the embodiment including the first running board 30 and the second running board 32, the vehicle 20 may include a total of four actuators 48, two for each of the first running board 30 and the second running board 32. Similarly, in the embodiment including four running boards, the vehicle 20 may include a total of eight actuators 48, two for each of the first running board 30, the second running board 32, the third running board 44, and the fourth running board 46. Additionally, the vehicle 20 may include one or more manifolds (not shown) configured to cooperate with the one or more actuators 48.

Referring to FIG. 5, the vehicle 20 also includes a control module 50. The control module 50 is configured for transmitting the signal to the actuator 48. The control module 50 may be, for example, an on-board vehicle computer. In one embodiment, the control module 50 also communicates with a memory module (not shown) and one or more vehicle sensors (not shown) according to a control scheme. The control scheme may be designed to allow the occupant to select and set occupant preferences for deployment and retraction of each of the first running board 30 and the second running board 32 upon closing and/or opening of the front door 26 and/or the rear door 28 for ingress and/or egress. Similarly, in the embodiment including the third running board 44 and the fourth running board 46, the occupant may select and set occupant preferences for deployment and retraction of each of the third running board 44 and the fourth running board 46 upon closing and/or opening of the front door 26 of the passenger side 224 and/or the rear door 28 of the passenger side 224 of the vehicle 20 for ingress and/or egress and/or access to the roof of the vehicle 20. The occupant preferences may be stored in the memory module.

The one or more vehicle sensors may monitor and report a status of the front door 26 and the rear door 28 of the driver side 124 of the vehicle 20 and of the front door 26 and the rear door 28 of the passenger side 224 of the vehicle 20. For example, the one or more vehicle sensors may monitor and report whether the front door 26 and/or the rear door 28 is presently open or closed. The one or more vehicle sensors may also report a position of one or more running boards, e.g., whether the first running board 30 is deployed or retracted. Further, the one or more vehicle sensors may monitor and report whether the vehicle 20 is moving, may monitor and report a position of a transmission (not shown) of the vehicle 20, and/or may determine whether a vehicle seat is occupied.

In operation, the control module 50 may communicate with each of the memory module and the one or more vehicle sensors, coordinates information received during the communication, and transmits the signal to the actuator 48 for individual deployment and/or retraction of each of the first running board 30 and the second running board 32. In the embodiment including the third running board 44 and the fourth running board 46, the control module 50 also may transmit the signal to the actuator 48 for individual deployment and/or retraction of each of the third running board 44 and the fourth running board 46.

Referring to FIG. 6, the vehicle 20 may also include a plurality of brackets 52. The plurality of brackets 52 may be configured for attaching each of the first running board 30 and the second running board 32 to the vehicle 20. The plurality of brackets 52 may be fixedly attached to the underside of the vehicle 20 and pivotably connected to each of the first running board 30 and the second running board 32 (not shown). That is, in operation, when the actuator 48 receives the signal from the control module 50 to deploy, the first running board 30, for example, pivots from the retracted position 37 underneath the vehicle 20 to a deployed position, e.g., the first position 38, the second position 40, and/or the third position 42, extending outwardly beneath the front door 26 of the driver side 124 to assist the occupant with ingress and/or egress of the vehicle 20 and/or to provide access to the roof of the vehicle 20. The plurality of brackets 52 may be configured to both securely attach the first running board 30, for example, to the vehicle 20 and pivot the first running board 30 to and from the deployed position and the retracted position 37.

In one embodiment, the vehicle 20 may include one bracket 52 per running board. In another embodiment, the vehicle 20 may include two brackets 52 per running board. In this embodiment, each of the two brackets 52 may be spaced apart from each other and disposed equidistant from a center of the running board.

The running board system 22 of the present invention assists occupants during ingress and egress of high ground clearance vehicles and/or provides access to the roof of the vehicle 20. Further, the vehicle 20 and running board system 22 are customizable according to individual occupant preferences during ingress and/or egress at each vehicle door, i.e., at each of the front door 26 and rear door 28 on the driver side 124, and at each of the front door 26 and the rear door 28 on the passenger side 224 of the vehicle 20. Since the running board system 22 may include the seal 43 and/or the deflector, the running board system 22 also provides a clean stepping surface for the occupant after the vehicle 20 has been exposed to debris. Finally, the running board system 22 may not add incremental weight to the vehicle 20. In particular, any additional weight associated with the plurality of brackets 52 may be offset by the cross-sectional thickness, t, of each of the first running board 30 and the second running board 32. Stated differently, since the length of each of the first running board 30 and the second running board 32 is less than a length of a conventional running board, the cross-sectional thickness, t, of each of the first running board 30 and the second running board 32 is generally less than a cross-sectional thickness of the conventional running board. Therefore, the running board system 22 may not add incremental weight to the vehicle 20. However, if additional weight is desirable, the running board system 22 may add incremental weight to the vehicle 20 via the plurality of brackets 52.

While the best modes for carrying out the invention have been described in detail, those familiar with the art to which this invention relates will recognize various alternative designs and embodiments for practicing the invention within the scope of the appended claims.

1. A running board system configured for enabling access to a vehicle having a plurality of doors on one side of the vehicle, the running board system comprising:
a first running board configured for enabling access to the vehicle via a front door on the side of the vehicle; and
a second running board configured for enabling access to the vehicle via a rear door on the side of the vehicle;
wherein each of said first running board and said second running board is individually deployable upon opening of the front door or the rear door.

2. The running board system of claim 1, wherein each of said first running board and said second running board is individually retractable upon closing of the front door or the rear door.

3. The running board system of claim 1, wherein each of said first running board and said second running board is individually deployable upon opening of the front door or the rear door, respectively.

4. The running board system of claim 2, wherein each of said first running board and said second running board is individually deployable upon opening of the front door or the rear door, respectively.

5. The running board system of claim 2, wherein each of said first running board and said second running board is individually retractable upon closing of the front door or the rear door, respectively.

6. The running board system of claim 4, wherein each of said first running board and said second running board is individually retractable upon closing of the front door or the rear door, respectively.

7. The running board system of claim 1, wherein each of said first running board and said second running board is powered.

8. The running board system of claim 2, wherein each of said first running board and said second running board is powered.

9. The running board system of claim 1, wherein each of said first running board and said second running board is longitudinally-elongated.

10. The running board system of claim 1, wherein each of said first running board and said second running board is configured for deflecting debris when disposed in a retracted position.

11. The running board system of claim 1, wherein said first running board is disposed beneath the front door of the vehicle.

12. The running board system of claim 11, wherein said second running board is disposed beneath the rear door of the vehicle.

13. The running board system of claim 1, wherein each of said first running board and said second running board is individually deployable to a plurality of positions.

14. A running board system configured for enabling access to a vehicle having a plurality of doors on each of two sides of the vehicle, the running board system comprising:
a first running board configured for enabling access to the vehicle via a front door of a driver side of the vehicle;
a second running board configured for enabling access to the vehicle via a rear door of the driver side of the vehicle;
a third running board configured for enabling access to the vehicle via a front door of a passenger side of the vehicle; and
a fourth running board configured for enabling access to the vehicle via a rear door of the passenger side of the vehicle;
wherein each of said first running board and said second running board is individually deployable upon opening of the front door of the driver side or the rear door of the driver side;
wherein each of said first running board and said second running board is individually retractable upon closing of the front door of the driver side or the rear door of the driver side;
wherein each of said third running board and said fourth running board is individually deployable upon opening of the front door of the passenger side or the rear door of the passenger side;
wherein each of said third running board and said fourth running board is individually retractable upon closing of the front door of the passenger side or the rear door of the passenger side.

15. The running board system of claim 14, wherein each of said first running board and said second running board is individually deployable upon opening of the front door of the driver side or the rear door of the driver side, respectively, and wherein each of the first running board and the second running board is individually retractable upon closing of the front door of the driver side or the rear door of the driver side, respectively.

16. The running board system of claim 14, wherein each of said third running board and said fourth running board is individually deployable upon opening of the front door of the passenger side or the rear door of the passenger side, respectively, and wherein each of said third running board and said fourth running board is individually retractable upon closing of the front door of the passenger side or the rear door of the passenger side, respectively.

17. The running board system of claim 14, wherein each of said first running board, said second running board, said third running board, and said fourth running board is powered.

18. The running board system of claim 14, wherein each of said first running board, said second running board, said third running board, and said fourth running board is configured for deflecting debris when disposed in a retracted position.

19. A vehicle comprising:
a plurality of doors on one side of said vehicle;
a running board system configured for enabling access to said vehicle, said running board system including;
a first running board configured for enabling access to said vehicle via a front door on said side of said vehicle; and
a second running board configured for enabling access to said vehicle via a rear door on said side of said vehicle;
an actuator configured for receiving a signal and individually deploying and individually retracting each of said first running board and said second running board; and
a control module configured for transmitting said signal to said actuator;
wherein each of said first running board and said second running board is individually deployable upon opening of said front door or said rear door;
wherein each of said first running board and said second running board is individually retractable upon closing of said front door or said rear door.

20. The vehicle of claim 19, comprising a plurality of brackets configured for attaching each of said first running board and said second running board to said vehicle.
